(19) United States
(12) Patent Application Publication
(10) Pub. No.: US 2016/0259573 A1
(43) Pub. Date: Sep. 8, 2016

(54) VIRTUAL TAPE STORAGE USING INTER-PARTITION LOGICAL VOLUME COPIES

(71) Applicant: INTERNATIONAL BUSINESS MACHINES CORPORATION, Armonk, NY (US)

(72) Inventors: David A. BRETTELL, Vail, AZ (US); Vanessa R. EARLE, Tucson, AZ (US); Alan J. FISHER, Tucson, AZ (US); Duke A. LEE, Tucson, AZ (US)

(73) Assignee: INTERNATIONAL BUSINESS MACHINES CORPORATION, Armonk, NY (US)

(21) Appl. No.: 14/636,869

(22) Filed: Mar. 3, 2015

(51) Int. Cl. G06F 3/06

(52) U.S. Cl. CPC G06F 3/0619; G06F 3/0689; G06F 3/0665; G06F 3/065

(57) ABSTRACT

Methods, systems, and computer program product embodiments for storing data in a virtual data storage environment, by a processor device, are provided. In a virtualized tape storage environment, a plurality of partitions are created on a single node, each partition having unique attributes allowing for specific data management, and a logical volume is replicated across the plurality of partitions, such that the logical volume is redundantly stored in at least one of the plurality of partitions.

### BACKGROUND OF THE INVENTION

1. Field of the Invention

The present invention relates in general to computers, and more particularly to a method, system, and computer program product for improved virtual tape storage using inter-partition logical volume copies.

2. Description of the Related Art

In today's society, computer systems are commonplace. Computer systems may be found in the workplace, at home, or at school. Computer systems may include data storage systems, or disk storage systems, to process, store, and archive data. Large data archiving solutions typically use tape library systems where workstations and client devices are connected to one or more servers, and the servers are connected to one or more libraries. In data centers, such as those providing imaging for health care, entertainment, weather, military, and space exploration applications, these servers and libraries are often interconnected in a grid-computing environment.

### SUMMARY OF THE DESCRIBED EMBODIMENTS

Various embodiments for storing data in a virtualized storage environment are provided. In one embodiment, the method comprises creating a plurality of partitions on a single node, each partition having unique attributes allowing for specific data management, and replicating a logical volume across the plurality of partitions, wherein the logical volume is redundantly stored in at least one of the plurality of partitions.

In addition to the foregoing exemplary embodiment, various other system and computer program product embodiments are provided and supply related advantages. The foregoing summary has been provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict embodiments of the invention and are not therefore to be considered to be limiting of its scope, the invention will be described and explained with additional specificity and detail through the use of the accompanying drawings, in which:

FIG. 1A is a block diagram illustrating a typical client-server library system for archiving data in which aspects of the invention can be implemented;

FIG. 1B is a block diagram illustrating a typical grid computing client-server library environment for archiving data in which aspects of the invention can be implemented;

FIG. 2 is a block diagram illustrating a representative computer system which may be used as a client or a server computer;

FIG. 3 illustrates a typical data storage tape library for archiving data in which aspects of the present invention may be implemented upon;

FIG. 4 illustrates an example of a tape cartridge media for use in the data storage tape library in FIG. 3;

FIG. 5 illustrates a block diagram showing an exemplary data storage tape library in communication with a host computer for providing aspects of the invention;

FIG. 6 illustrates a block diagram representative of functionality according to one aspect of the present invention; and

FIG. 7 illustrates a flow chart representative of functionality according to one aspect of the present invention.

### DETAILED DESCRIPTION OF THE DRAWINGS

With increasing demand for faster, more powerful and more efficient ways to store information, optimization of storage technologies is becoming a key challenge, particularly in tape drives. In magnetic storage systems, data is read from and written onto magnetic recording media utilizing magnetic transducers commonly. Data is written on the magnetic recording media by moving a magnetic recording transducer to a position over the media where the data is to be stored. The magnetic recording transducer then generates a magnetic field, which encodes the data into the magnetic media. Data is read from the media by similarly positioning the magnetic read transducer and then sensing the magnetic field of the magnetic media. Read and write operations may be independently synchronized with the movement of the media to ensure that the data can be read from and written to the desired location on the media.

A virtual tape library (VTL) is a data storage virtualization technology employing a storage component (usually hard disk storage) as tape libraries or tape drives for use with existing backup software. Virtualizing the disk storage as tape allows integration of VTLs with existing backup software and existing backup and recovery processes and policies. The benefits of such virtualization include storage consolidation and faster data restore processes.

Depending upon the implementation, different tape storage and virtual tape storage products offer each a unique set of characteristics and areas of specialty. Presently, for example, the IBM TS7700™ Series of Enterprise Tape Storage Solutions consist of two models, the TS7720 Virtualization Engine (TS7720 VE™) and TS7740 Virtualization Engine (TS7740 VE™).

The TS7720 VE™ has a very large Tape Volume Cache (TVC) that can hold many logical volumes written by a host system but has no physical library attachment. Because the logical volumes are always resident in cache, a host mount of a logical volume is fulfilled quickly by the TS7720 VE™. However, as logical volumes written to the disk cache increase, the TVC's free space decreases. When the disk cache is near full, host jobs are heavily throttled and may time out or abend. Data must be managed to prevent the TVC on the TS7720 VE™ from filling to capacity.

On the other hand, the TS7740 VE™ has a small cache capacity, however has an attachment to a physical tape library providing unlimited storage on physical tapes. On the TS7740 VE™, it is possible to have three consistent copies of a logical volume: one temporary copy in the TVC and two permanent copies on physical tape (a primary tape copy and secondary tape copy). Due to the smaller cache capacity of the TS7740 VE™, the logical volume copy in the TVC will likely be removed once it is written to tape. Because the host system always accesses the logical volume copy that resides in the TVC, a recall may need to be done on a TS7740 VE™. A recall of a logical volume may take several minutes because the process requires mounting the physical tape to a tape drive and copying the data from physical tape back to the TVC.

These unique advantages and disadvantages to systems, such as the aforementioned IBM TS7720 VE™ and the IBM TS7740 VE™ illustrate one of many areas for improvement that may be made to logical volume retention and availability in both a stand-alone and grid environment.

Accordingly, embodiments for storing data in a virtualized storage environment are provided. As will be discussed below, one embodiment comprises creating a plurality of partitions on a single node, each partition having unique attributes allowing for specific data management, and replicating a logical volume across the plurality of partitions, such that the logical volume is redundantly stored in at least one of the plurality of partitions.

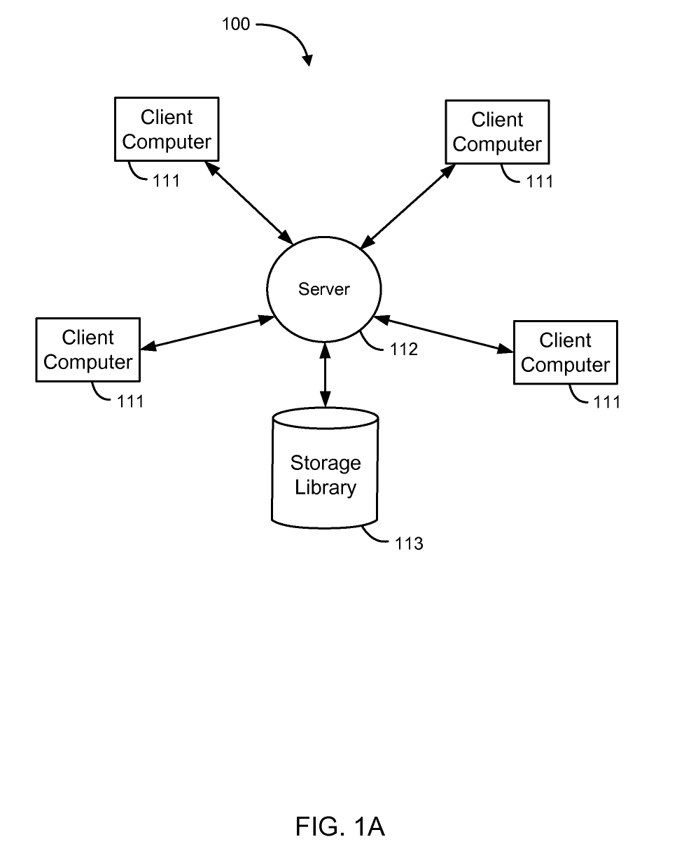

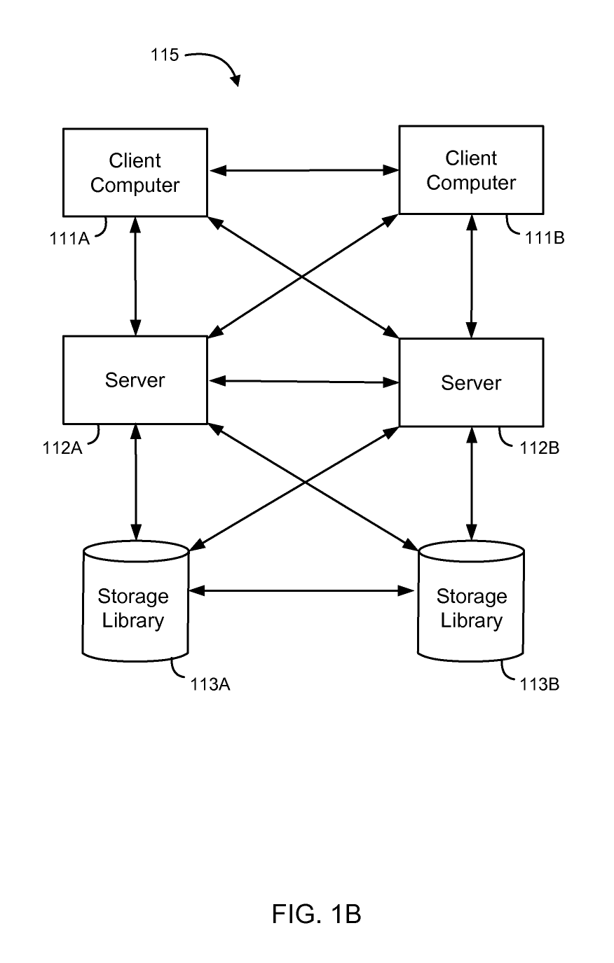

Turning now to the Figures, and in particular to FIG. 1A, there is depicted a block diagram of client-server library system 100 for archiving data in which aspects of the present invention may be implemented. The system 100 includes multiple client computers 111 from which data is transmitted to a server 112 for archiving in a data storage library 113. The client computers 111 also retrieve previously archived data from the library 113 through the server 112. Client computers 111 may be personal computers, portable devices (e.g., PDAs), workstations, or server systems, such as the IBM TS7720™. The client computers 111 may be connected to the server 112 through a local area network such as an Ethernet network, or by SCSI, iSCSI, Fibre Channel, Fibre Channel over Ethernet, or Infiniband. Server 112 may again be an IBM TS7740™ server, TS7720™ server, or other servers. Similarly, the data storage library 113 may be connected to the server 112 using a high data rate connection such as an optical or copper fiber channel, SCSI, iSCSI, Ethernet, Fibre Channel over Ethernet or Infiniband.

FIG. 1B illustrates a block diagram of a typical grid computing library environment 115 for archiving data. The library environment 115 includes multiple client computers 111A and 111B interconnected to one another and to multiple server systems 112A and 112B. The server systems 112A and 112B are interconnected to one another and to multiple tape libraries 113A and 113B, which are also interconnected to one another.

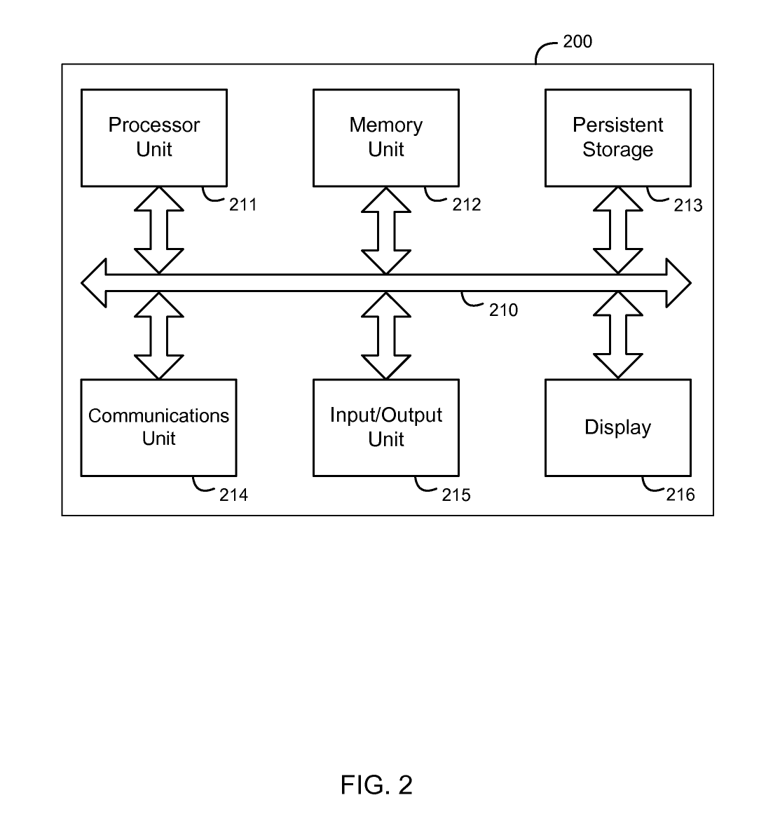

FIG. 2 illustrates a block diagram of a data processing system that may be used as a client computer 111 or server system 112. As shown, a data processing system 200 includes a processor unit 211, a memory unit 212, a persistent storage 213, a communications unit 214, an input/output unit 215, a display 216 and a system bus 210. Computer programs are typically stored in the persistent storage 213 until they are needed for execution, at which time the programs are brought into the memory unit 212 so that they can be directly accessed by the processor unit 211. The processor unit 211 selects a part of memory unit 212 to read and/or write by using an address that the processor 211 gives to memory 212 along with a request to read and/or write. Usually, the reading and interpretation of an encoded instruction at an address causes the processor 211 to fetch a subsequent instruction, either at a subsequent address or some other address. The processor unit 211, memory unit 212, persistent storage 213, communications unit 214, input/output unit 215, and display 216 interface with each other through the system bus 210.

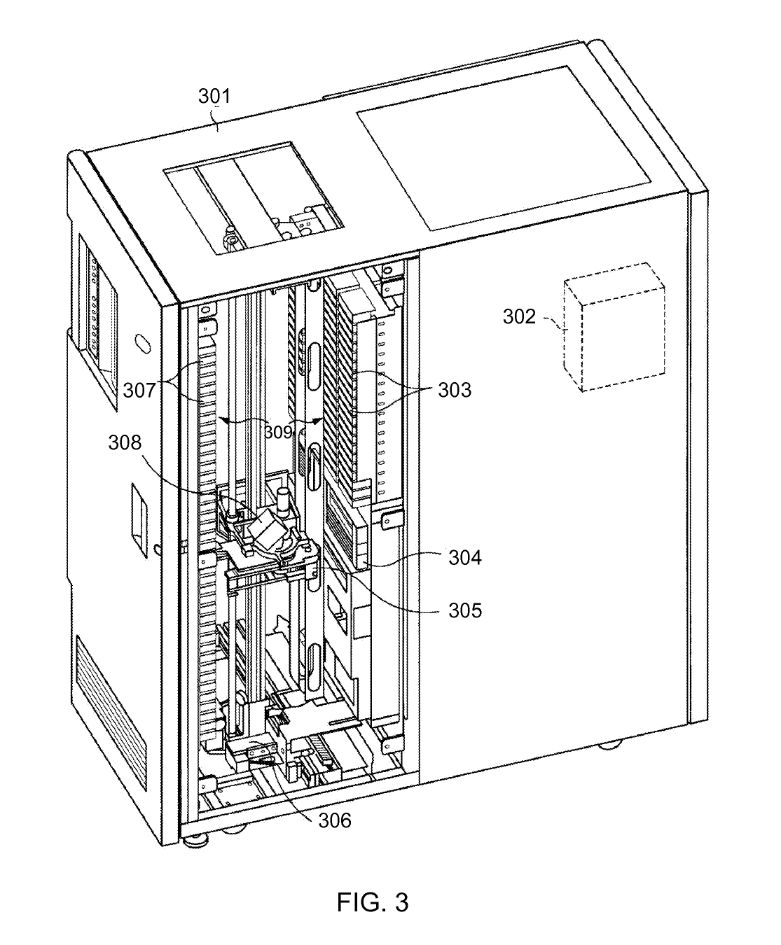

FIG. 3 illustrates an example of a data storage library 301 which may be found in an environment of an implementation of the present invention. The library 301 is an automated tape library that accommodates multiple tape drives 304 for reading and writing on tape media, such as single-reel or two-reel magnetic tape cartridges. Examples of the library 301 include IBM TS3400™ and TS3500™ Tape Libraries, IBM TotalStorage™ 3494 Tape Libraries, and IBM 3952™ Tape Frames Model C20, which store magnetic tape cartridges and use IBM TS1130™ tape drives. Other examples of the library 301 include IBM TS3310™ and TS3100/3200™ tape libraries which store magnetic tape cartridges and use IBM LTO (Linear Tape Open) tape drives. A plurality of tape media 303 are stored in banks or groups of storage slots 309. Tape media may encompass a variety of media, such as that contained in magnetic tape cartridges, magnetic tape cassettes, and optical tape cartridges, in various formats. For universal reference to any of these types of media, the terms “tape media” or “media” are used herein, and any of these types of containers are referred to as “tape cartridges” or “cartridges” herein. An access robot 306, including a cartridge picker 305 and a bar code reader 308 mounted on the picker, transports a selected cartridge 303 between a storage slot 309 and a drive 304.

The library 301 further has a library controller 302 which includes at least one microprocessor. The library controller 302 may serve to provide an inventory of the cartridges 303 and to control the library 301. Typically, the library controller 302 has suitable memory and data storage capability to control the operation of the library 301. The library controller 302 controls the actions of the access robot 306, cartridge picker 305, and bar code reader 308. The library controller 302 is interconnected through an interface to one or more host processors, which provides commands requesting access to particular tape media or to media in particular storage slots. A host, either directly, or through the library controller, controls the actions of the data storage drives 304. Commands for accessing data or locations on the tape media and information to be recorded on, or to be read from, selected tape media are transmitted between the drives 304 and the host. The library controller 302 is typically provided with a database for locating the tape cartridges 303 in the appropriate storage slots 309 and for maintaining the cartridge inventory.

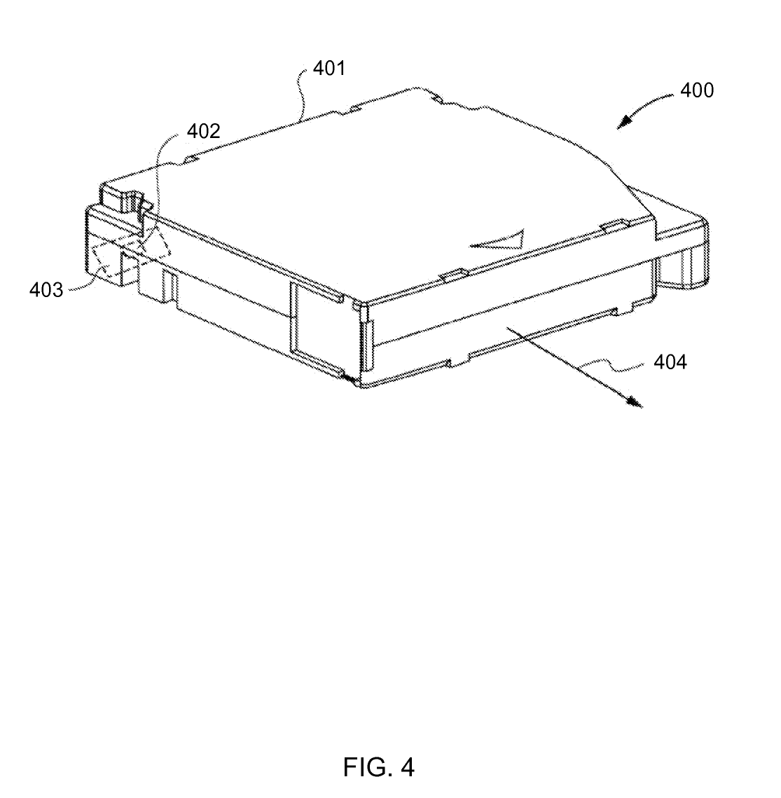

FIG. 4 illustrates a perspective view of an exemplary tape cartridge 400 for use in a tape drive system 304 of FIG. 3. The tape cartridge 400 has a reel (not shown) for holding tape media (not shown) which is wound around the reel hub. The tape cartridge 400 further includes an RFID cartridge memory 402 which is on printed circuit board 403, for wireless interfacing with the tape drive 304 and the cartridge picker 305. The tape cartridge 400 is referred to as a single-reel cartridge as it includes only one tape reel which acts as a supply reel during operation. A take-up reel is provided in the tape drive 304 for receiving the tape media when the tape media is being unspooled from the tape reel. In a different design of the tape drive 304, a take-up reel might be included in the cartridge 400 itself rather than in the tape drive 304. Such a tape cartridge is referred to as a dual-reel cartridge. Cartridge 400 is inserted along direction 404 into tape drive 304.

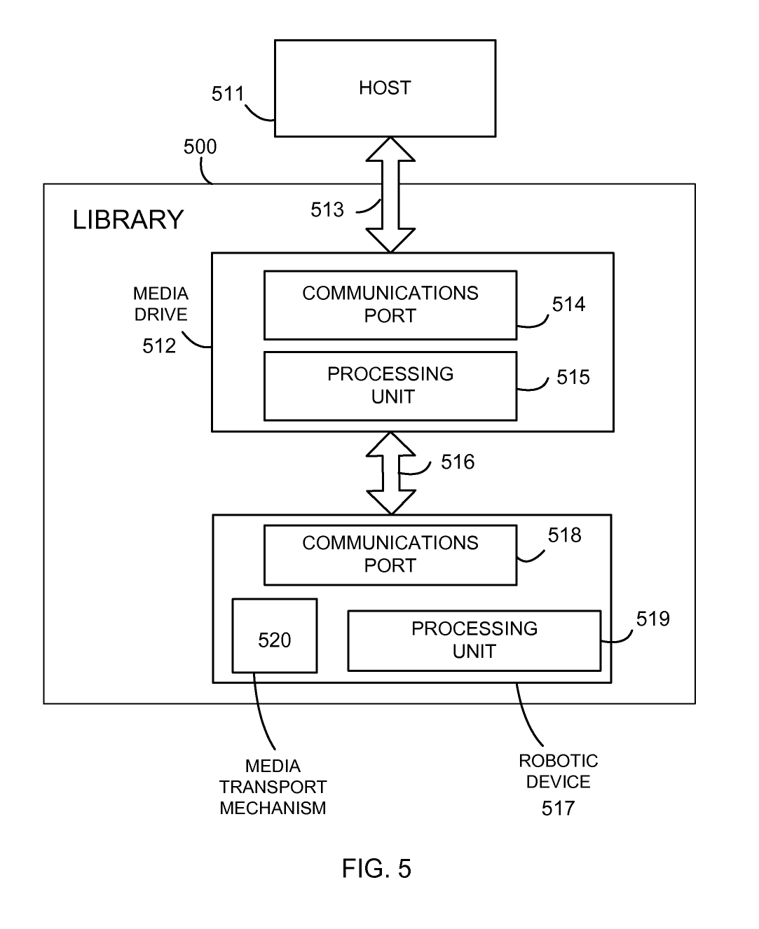

FIG. 5 is a block diagram showing the functional components of an exemplary data storage tape library 500 in communication with a host computer 511 for providing aspects of the invention. The library 500 is attached to a host 511, and includes a media drive 512 and a robotic device 517. Data and control path 513 interconnects the host 511 and drive 512. Similarly, data and control path 516 interconnects the drive 512 and the robotic device 517. The paths 513 and 516 may comprise suitable means for conveying signals, such as a bus with one or more conductive members (such as wires, conductive traces, cables, etc.), wireless communications (such as radio frequency or other electromagnetic signals, infrared communications, etc.), and fiber optic communications. Furthermore, the paths 513 and 516 may employ serial, parallel, or another communications format, using digital or analog signals as desired. Communications with the media drive 512 and robotic device 517 are through communications ports 514 and 518, respectively.

Both the drive 512 and the robotic device 517 include respective processing units 515 and 519. The library 500 manages the positioning and access of removable or portable data storage media such as magnetic tape, cartridge 400, optical tape, optical disk, removable magnetic disk drive, CD-ROM, digital video disk (DVD), flash memory, or another appropriate format. Some of these types of storage media may be self-contained within a portable container, or cartridge. For universal reference to any of these types of storage media, this disclosure refers to them as media.

The host 501 may be a server, workstation, personal computer, or other means for exchanging data and control signals with the media drive 512. The drive 512 comprises a machine for reading data from and/or writing data to exchanging data with a portable data storage media. The robotic device 517 includes the processing unit 519 and a media transport mechanism 520 coupled to processing unit 519. The media transport mechanism 520 includes servos, motors, arms, grippers, sensors and other robotic, mechanical and electrical equipment to perform functions that include (at least) the transportation of media items between the drive 512, various storage bins (not shown), import/export slots, etc. The mechanism 520 may, for example, comprise an auto-loader mounted to the drive 512, a robotic arm housed inside a mass storage library, or another suitable device. As an example, the mechanism 520 may comprise an access robot 306, cartridge picker 305 and bar code reader 308 from FIG. 3.

The present invention provides for a system in which there are multiple partitions. In one embodiment, for example, there may be one resident partition and one to seven tape partitions. Using an inter-partition copies (IPC) function, the present invention extends availability of a logical volume to host systems attached to a cluster by allowing for multiple copies of the logical volume to be replicated and stored within the partitions on a single node. Additionally, the IPC function allows for greater redundancy and accessibility at a disaster recovery site than current methods.

Presently, only one copy of a logical volume may be achieved on system such as the aforementioned. With the benefit of the IPC function, a user has the ability to have a stand-alone storage server (such as the IBM TS 7720™) and still maintain redundant copies. This effectively comprises one machine working as two. One embodiment, for example, may have data from an incoming host directed to a resident partition and once the volume is complete, a redundant copy will be created on to the tape partition and will be migrated out to physical tape.

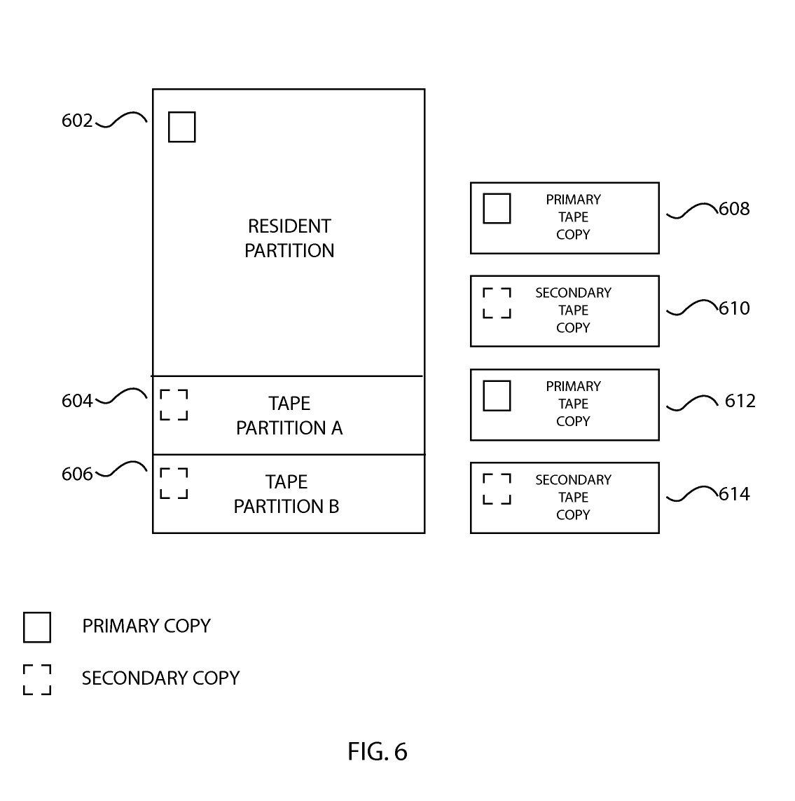

As mentioned, there is presently only one copy of a logical volume in cache. A cluster with a physical tape library attachment can have a primary copy and a secondary copy on physical tape. With IPC functionality, it is possible to have more than one copy of the logical volume in cache. FIG. 6 illustrates one example of a common configuration according to one embodiment of the present invention. A primary copy of the logical volume may be stored on a tapeless (resident) partition 602, a secondary copy on tape partition A 604, and another secondary copy on tape partition B 606. Additionally, each logical volume in a tape partition may have a primary copy on tape 608, 612, and a secondary copy on tape 610, 614. This way, each of the secondary copies on tape may be copied, exported, and stored offsite in a data vault, for example, even at separate locations. Each of the primary copies of the logical volume on tape would remain in the physical tape library.

A significant advantage of IPC functionality is the ability to put a server such as the TS7700™ Series into a service mode by logical partition. Presently, when the TS7700™ Series is put into service mode, the entire system will enter the mode, rendering host systems no longer able to access the logical volumes on that cluster (node). With IPC functionality, it is possible to put only one or more logical partition in service mode, whereas the online partitions will allow host access to online logical volumes. In this way, the host cannot access only logical volumes residing in a partition that has been placed into a service mode. This ultimately reduces impact to host systems due to service actions and improves the availability of logical volumes.

### Storage Constructs

In one embodiment, IPC functionality may be implemented as a configuration of a storage servers' storage constructs. Storage constructs are policies that define how the virtualization engine should manage the logical volumes. More specifically, the implementation may be configured under a storage class, such that a storage administrator is allowed to associate a storage class with a tapeless partition and a tape library partition. Additionally, the logical volume that is in a tape library partition may be specified to have both a primary copy and a secondary copy on physical tape. The secondary copy of the logical volume may be copied, exported, and stored offsite.

### Logical Volume Constructs Database Record

Presently, a logical volume constructs record in the database contains the partition number to which the logical volume resides. In one embodiment using IPC functionality, the partition number will become a bit mask indicating all the partitions in which the logical volume resides in. For example:
0x0001—Partition 0
0x0002—Partition 1
0x0004—Partition 2
0x0008—Partition 3
0x0010—Partition 4
0x0020—Partition 5
0x0040—Partition 6
0x0080—Partition 7
   A value of 0x0003, for example, indicates the logical volume exists in partitions 0 and 1.

### Logical Volume Naming Convention for Multiple Copies in Cache

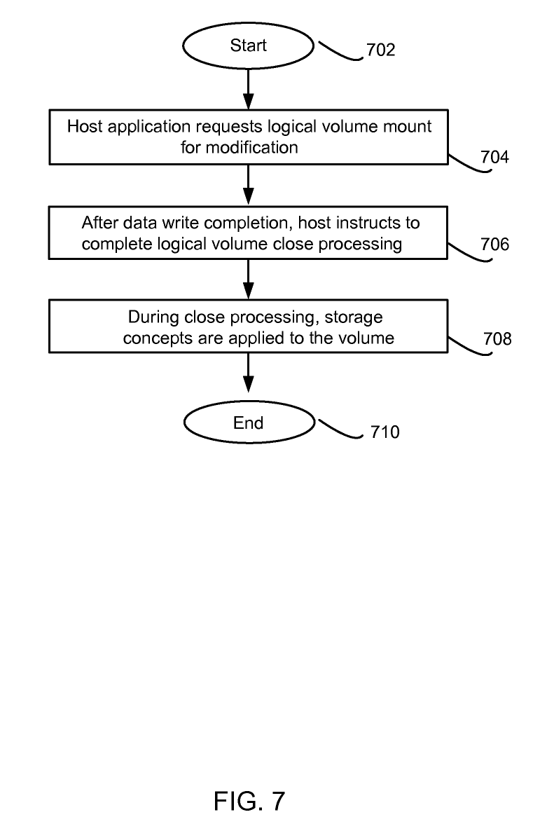

In one embodiment, a logical volume is modified including naming for multiple copies residing in cache. FIG. 7 illustrates a flow chart of one example of one embodiment of this functionality. Starting at 702, a host application requests the storage server to mount a logical volume for modification 704. After all data has been written to the logical volume, the host instructs the storage server to complete logical volume close processing 706. During close processing, the storage server applies the storage concepts associated with the logical volume 708. A logical volume copy residing in a tapeless partition will retain a six-character file name, for example, VOL001. The logical volume copy that is made for the tape library partition is recorded in the form of the file in the tapeless partition with the extension “.CP#”, where # is the partition number. For example, the file name may be VOL001.CP1, for a logical volume residing in logical cache partition 1.

### Logical Volume to Physical Volume Mapping

Traditionally there are only up to two logical volume-to-physical volume database records that map a logical volume to a logical position on a physical volume. In one embodiment of the present invention using IPC functionality, each tape partition may have up to two logical volume-to-physical volume records. Therefore, if there are seven tape partitions, for example, there may be a total of fourteen logical volume-to-physical volume records. Moreover, utilizing a storage pool property, it may be configured such that each logical volume written to tape is stored on a different media type and recording format supported by the installed drive types, allowing exported tapes to be supported by a disaster recovery test site with a specific drive type.

When a host mounts a logical volume for writing, all logical volume-to-physical volume records are deleted on the first write, or append. Similarly, under one embodiment, when a new copy of the logical volume is copied from another cluster, all logical volume-to-physical volume records are deleted.

### Host Access to Logical Volumes

In one embodiment, during a request by a host system to access a private logical volume (not a scratch logical volume), the IPC function mounts the logical volume in the following manner:
1. If the logical volume exists in the resident partition, the mount completion is returned immediately to the host,
2. If the logical volume exists in a tape partition, mount completion is returned, and
3. If the logical volume exists on tape, the tape containing the logical volume is mounted such that the starting logical tape position is closest to the beginning of tape for recall efficiency.

### Delete Expire Processing

Storage servers, such as the IBM TS 7720™ include delete expire processing functionality. When a logical volume undergoes delete expire processing, the data is deleted from cache and also the logical volume maps-to-physical volume records are removed. Once the logical volume maps-to-physical volume records are deleted, it is very difficult to restore the data if the action was inadvertently initiated. In one embodiment of the present invention utilizing IPC functionality, the delete expire processing algorithm may change such that each logical volume copy per logical partition may or may not have an associated expired time. For example, if a logical volume has a copy in the resident partition and another in a tape partition, the copy in the resident partition may be deleted while the copy on tape remains fully accessible until the host application needs to reuse the logical volume as scratch. This provides a safety buffer for data that was inadvertently placed for delete expire processing.

### Logical Volume Auto-Removal Processing

Another function of such storage servers previously mentioned is auto-removal processing in a grid environment. Using this method, a removal threshold is configured, or a value specifying the amount of cache free space remaining before the storage server automatically removes a logical volume from the TVC as long as there is another valid copy of the logical volume in another cluster in the grid. If the removed logical volume is ever needed by a host attached to the local cluster, it is copied from another cluster back to the local cluster to fulfilled the host mount.

This functionality ceases, however, on a stand-alone system or if there is no logical volume copy on another cluster in the grid. In one embodiment of the present invention utilizing IPC functionality, this process may now remove the logical volume copy that is in the resident partition if there is another copy of the logical volume in at least one other tape partition. In one embodiment, this is achieved through database fields that may be added to the volume token record indicating to which partitions the logical volume resides. Using this configuration, the logical volume record will also contain the residency status (resident in cache, premigrated, or migrated) of each logical volume copy per logical partition, a premigrated logical volume being one that resides in cache and also on physical tape, and a migrated logical volume being one that resides only on physical tape.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While one or more embodiments of the present invention have been illustrated in detail, the skilled artisan will appreciate that modifications and adaptations to those embodiments may be made without departing from the scope of the present invention as set forth in the following claims.

What is claimed is:

1. A method for storing data in a virtual data storage environment, by a processor device, the method comprising:
in a virtualized tape storage environment, creating a plurality of partitions on a single node, each partition having unique attributes allowing for specific data management, and
replicating a logical volume across the plurality of partitions, wherein the logical volume is redundantly stored in at least one of the plurality of partitions.

2. The method of claim 1, further including redundantly storing a plurality of copies of the logical volume in the plurality of partitions in cache.

3. The method of claim 2, further including redundantly storing a plurality of copies of the logical volume in the plurality of partitions on physical media.

4. The method of claim 1, further including using an inter-partition copies (IPC) function to replicate and redundantly store multiple copies of the logical volume, wherein IPC is an aspect of a storage construct policy managed by a data virtualization engine.

5. The method of claim 4, further including applying the storage construct policy as a part of logical volume close processing, wherein attributes governing the replication and retention of the logical volume and its copies are written during close processing.

6. The method of claim 5, further including maintaining, by the logical volume, a database containing a record of each of the plurality of partitions the logical volume resides in.

7. The method of claim 6, wherein the record is a bit mask indicating all partitions to which the logical volume belongs.

8. The method of claim 4, further including mounting, by the IPC function a logical volume requested access by a host system, wherein the IPC function mounts the logical volume according to which partition it resides in.

9. A system for storing data in a virtual data storage environment, the system comprising:
a storage server operating in a virtualized tape storage environment, and
a processor device, controlling the storage server, wherein the processor device:
creates a plurality of partitions on a single node, each partition having unique attributes allowing for specific data management, and
replicates a logical volume across the plurality of partitions, wherein the logical volume is redundantly stored in at least one of the plurality of partitions.

10. The system of claim 9, wherein the processor device redundantly stores a plurality of copies of the logical volume in the plurality of partitions in cache.

11. The system of claim 10, wherein the processor device redundantly stores a plurality of copies of the logical volume in the plurality of partitions on physical media.

12. The system of claim 9, wherein the processor device uses an inter-partition copies (IPC) function to replicate and redundantly store multiple copies of the logical volume, wherein IPC is an aspect of a storage construct policy managed by a data virtualization engine.

13. The system of claim 12, wherein the processor device applies the storage construct policy as a part of logical volume close processing, wherein attributes governing the replication and retention of the logical volume and its copies are written during close processing.

14. The system of claim 13, wherein the processor device instructs the logical volume to maintain a database containing a record of each of the plurality of partitions the logical volume resides in.

15. The system of claim 14, wherein the record is a bit mask indicating all partitions to which the logical volume belongs.

16. The system of claim 12, wherein the processor device instructs the IPC function to mount a logical volume requested access by a host system, wherein the IPC function mounts the logical volume according to which partition it resides in.

17. A computer program product for storing data in a virtual data storage environment by a processor device, the computer program product comprising a non-transitory computer-readable storage medium having computer-readable program code portions stored therein, the computer-readable program code portions comprising:
a first executable portion that in a virtualized tape storage environment, creates a plurality of partitions on a single node, each partition having unique attributes allowing for specific data management, and
a second executable portion that replicates a logical volume across the plurality of partitions, wherein the logical volume is redundantly stored in at least one of the plurality of partitions.

18. The computer program product of claim 17, further including a third executable portion that redundantly stores a plurality of copies of the logical volume in the plurality of partitions in cache.

19. The computer program product of claim 18, further including a fourth executable portion that redundantly stores a plurality of copies of the logical volume in the plurality of partitions on physical media.

20. The computer program product of claim 17, further including a third executable portion that uses an inter-partition copies (IPC) function to replicate and redundantly store multiple copies of the logical volume, wherein IPC is an aspect of a storage construct policy managed by a data virtualization engine.

21. The computer program product of claim 20, further including a fourth executable portion that applies the storage construct policy as a part of logical volume close processing, wherein attributes governing the replication and retention of the logical volume and its copies are written during close processing.

22. The computer program product of claim 21, further including a fifth executable portion that maintaining, by the logical volume, a database containing a record of each of the plurality of partitions the logical volume resides in.

23. The computer program product of claim 22, wherein the record is a bit mask indicating all partitions to which the logical volume belongs.

24. The computer program product of claim 20, further including a fourth executable portion that mounting, by the IPC function a logical volume requested access by a host system, wherein the IPC function mounts the logical volume according to which partition it resides in.
